(19) United States
(12) Patent Application Publication
(10) Pub. No.: US 2005/0181139 A1
(43) Pub. Date: Aug. 18, 2005

(54) Process for applying a multi-layer coating to ferrous substrates

(76) Inventors: Dennis W. Jones, Glenshaw, PA (US); Gregory J. McCollum, Gibsonia, PA (US); Mark McMillen, Cabot, PA (US); Anthony J. Notte, Cranberry Township, PA (US); Michael J. Pawlik, Glenshaw, PA (US); Steven D. Perrine, Allison Park, PA (US); Michael L. White, Oswego, PA (US)

Correspondence Address: PPG INDUSTRIES, INC.;Intellectual Property Dept., One PPG Place, Pittsburgh, PA, 15272, US

(21) Appl. No.: 11/036,453

(22) Filed: Jan. 14, 2005

Related U.S. Application Data
(60) Provisional application No. 60/537,102, filed on Jan. 16, 2004.

(51) Int. Cl. B05D 7/00

(52) U.S. Cl. 427/402

(57) ABSTRACT

The present invention is drawn to a process for applying a multi-layer coating to at least a portion of a ferrous substrate. The process comprises the steps of: (a) providing a ferrous substrate; (b) applying to at least a portion of the ferrous substrate a film-forming composition that contains at least one of a corrosion inhibiting pigment and an electroconductive pigment; (c) curing the film-forming composition that was applied to the ferrous substrate in step (b); (d) forming the ferrous substrate into an end-use shape; (e) contacting at least a portion of the formed ferrous substrate with a treatment composition to yield a treated substrate; and (f) applying at least one coating composition to at least a portion of the treated substrate to form a coated substrate. The treatment composition comprises an aqueous solution of a polymer derived from vinylidene chloride.

### CROSS-REFERENCE TO RELATED APPLICATIONS

This application claims the benefit of priority of U.S. Provisional Application No. 60/537,102, filed Jan. 16, 2004.

### FIELD OF THE INVENTION

This invention relates generally to processes for applying multi-layer coatings to ferrous substrates, including formed ferrous substrates, in order to provide improved corrosion resistance.

### BACKGROUND OF THE INVENTION

The production of light gauge steel for end uses ranging from architectural construction materials to automobiles is well known. A rolling mill line produces continuous sheets of steel in the required thickness and width. The steel sheets may be coated with a thin layer of zinc metal via a galvanizing process. Eventually, mill oil is applied to the uncoated or galvanized steel sheets, and the steel is either stored or shipped in a coil to a customer for further processing.

Typically, the customer is an automobile manufacturer who will take the coiled metal sheet, often apply a weldable primer, and pass it through a lubricating station and then to a forming operation where the metal sheet is cut and formed into a part such as a roof, fender, door, etc. The parts are then welded together to form an automobile body. Next, the automobile body is typically cleaned, treated with a zinc phosphating solution to enhance corrosion protection, and rinsed with deionized water. The treated automobile body is then passed through an electrodeposition bath where a corrosion resistant primer is applied prior to any decorative top coats.

Automobile manufacturers would like to streamline their operations and perhaps eliminate more costly processing steps without sacrificing corrosion resistance of the substrates. This is particularly true for the design and building of new manufacturing plants where the elimination of processing equipment such as pretreatment and/or electrodeposition tanks could lead to very great capital and space savings.

It would be desirable to provide a process for applying multi-layer treatment coatings to a substrate that would provide exceptional corrosion resistance thereto while eliminating the need for pretreatment and/or electrodeposition steps.

### SUMMARY OF THE INVENTION

The present invention is drawn to a process for applying a multi-layer coating to at least a portion of a ferrous substrate. The process comprises the steps of:
(a) providing a ferrous substrate;
(b) applying to at least a portion of the ferrous substrate a film-forming composition that contains at least one of a corrosion inhibiting pigment and an electroconductive pigment;
(c) curing the film-forming composition that was applied to the ferrous substrate in step (b);
(d) forming the ferrous substrate into an end-use shape;
(e) contacting at least a portion of the formed ferrous substrate with a treatment composition to yield a treated substrate; and
   (f) applying at least one coating composition to at least a portion of the treated substrate to form a coated substrate. The treatment composition of step (e) comprises an aqueous solution of a polymer derived from vinylidene chloride. The process of the present invention often comprises one or more optional steps including but not limited to cleaning, one or more rinsing steps, heating, and applying at least one pretreatment composition and/or additional coating composition, without departing from the scope of the invention.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The ferrous metal substrates used in the practice of the present invention include iron, steel, and alloys thereof. Non-limiting examples of useful steel materials include cold rolled steel, galvanized (zinc coated) steel, electrogalvanized steel, stainless steel, pickled steel, zinc-iron alloy such as GALVANNEAL, and combinations thereof. Combinations or composites of ferrous and non-ferrous metals can also be used.

The shape of the ferrous metal substrate can be a sheet, plate, bar, rod or any shape desired. Often, the shape of the metal substrate is an elongated strip wound about a spool in the form of a coil. The process of the present invention is particularly suited for ferrous metal substrates that have been initially formed into an end-use shape, such as an automobile body part. One advantage of the process of the present invention when used to treat formed ferrous substrates is that any cut edges exposing bare metal and any weld spots made during the forming steps will be protected against corrosion without the need for costly pretreatment or electrodeposition baths. The thickness of the substrate typically ranges from 0.254 to 3.18 millimeters (mm) (10 to 125 mils), typically 0.6 to 1.2 mm (23.6 to 47.2 mil) although the thickness can be greater or less, as desired. The width of a coil strip generally ranges from 30.5 to 183 centimeters (12 to 72 inches), although the width of the substrate can vary depending upon its shape and intended use.

Before depositing any treatment or coating compositions upon the surface of the ferrous substrate, it is common practice to remove foreign matter from the metal surface by thoroughly cleaning and degreasing the surface. Such cleaning typically takes place after forming the substrate (stamping, welding, etc.) into an end-use shape. The surface of the ferrous substrate can be cleaned by physical or chemical means, such as mechanically abrading the surface or cleaning/degreasing with commercially available alkaline or acidic cleaning agents which are well known to those skilled in the art, such as sodium metasilicate and sodium hydroxide. A non-limiting example of a cleaning agent is CHEMKLEEN 163, an alkaline-based cleaner commercially available from PPG Industries, Inc.

Following the cleaning step, the ferrous substrate may be rinsed with deionized water or an aqueous solution of rinsing agents in order to remove any residue. The metal substrate can be air dried, for example, by using an air knife, by flashing off the water by brief exposure of the substrate to a high temperature or by passing the substrate between squeegee rolls.

In step (b) of the process of the present invention, a film-forming composition is applied to at least a portion of the ferrous substrate. The film-forming composition contains at least one of electroconductive pigments and corrosion inhibiting pigments dispersed throughout a binder, which may provide electroconductivity and cathodic protection to the film-forming composition.

Non-limiting examples of suitable electroconductive pigments include zinc, aluminum, iron, graphite, diiron phosphide and mixtures thereof. Commonly used zinc particles are commercially available from ZINCOLI GmbH as ZINCOLI S 620 or 520. The average particle size (equivalent spherical diameter) of the electroconductive pigment particles generally is less than about 10 micrometers, often ranges from about 1 to about 5 micrometers, and more often about 3 micrometers.

Non-limiting examples of suitable corrosion inhibiting pigments include zinc phosphate and molybdates such as calcium molybdate, zinc molybdate, barium molybdate and strontium molybdate; silicas such as oligomeric and/or polymeric silicon oxides; and mixtures thereof.

The binder is present to secure the pigments to the ferrous substrate. Typically, the binder forms a substantially continuous film when applied to the surface of the substrate. Generally, the amount of binder can range from about 5 to about 50 weight percent of the film-forming composition on a total solids basis, often about 10 to about 30 weight percent and more often about 10 to about 20 weight percent.

The binder in the film-forming composition applied in step (b) can comprise oligomeric binders, polymeric binders and mixtures thereof. The binder is usually a resinous polymeric binder material selected from thermosetting binders, thermoplastic binders or mixtures thereof. Non-limiting examples of suitable thermosetting materials include polyesters, epoxy-containing materials, phenoxy-containing materials, polyurethanes, and mixtures thereof, in combination with crosslinkers such as aminoplasts or isocyanates, which are discussed below. Non-limiting examples of suitable thermoplastic binders include high molecular weight epoxy resins, defunctionalized epoxy resins, vinyl polymers, polyesters, polyolefins, polyamides, polyurethanes, acrylic polymers and mixtures thereof. Examples of useful binder materials include phenoxy polyether polyols and inorganic silicates.

Particularly useful binder materials are polyglycidyl ethers of polyhydric phenols having a weight average molecular weight of at least about 2000 and preferably ranging from about 5000 to about 100,000. These materials can be epoxy functional or defunctionalized by reacting the epoxy groups with phenolic materials. Such binders can have epoxy equivalent weights of about 2000 to about one million. Non-limiting examples of useful epoxy resins are commercially available from Shell Chemical Company as EPON® epoxy resins. Preferred EPON® epoxy resins include EPON® 1009, which has an epoxy equivalent weight of about 2300-3800. Useful epoxy defunctionalized resins include phenoxy resins such as EPONOL resin 55-BK-30 which is commercially available from Shell.

Suitable crosslinkers or curing agents are described in U.S. Pat. No. 4,346,143 at column 5, lines 45-62 and include blocked or unblocked di- or polyisocyanates such as DESMODUR® BL 1265 toluene diisocyanate blocked with caprolactam, which is commercially available from Bayer, and aminoplasts such as etherified derivatives of urea-melamine- and benzoguanamine-formaldehyde condensates which are commercially available from CYTEC Industries under the trademark CYMEL® and from Solutia under the trademark RESIMENE®.

Weldable coating compositions often comprise one or more diluents for adjusting the viscosity of the composition so that it can be applied to the metal substrate by conventional coating techniques. The diluent should be selected so as not to detrimentally affect the adhesion of the weldable coating to the metal substrate. Suitable diluents include ketones such as cyclohexanone (preferred), acetone, methyl ethyl ketone, methyl isobutyl ketone and isophorone; esters and ethers such as 2-ethoxyethyl acetate, propylene glycol monomethyl ethers such as DOWANOL PM, dipropylene glycol monomethyl ethers such as DOWANOL DPM or propylene glycol methyl ether acetates such as PM ACETATE which is commercially available from Dow Chemical; and aromatic solvents such as toluene, xylene, aromatic solvent blends derived from petroleum such as SOLVESSO®. The amount of diluent can vary depending upon the method of coating, the binder components and the pigment-to-binder ratio, but generally ranges from about 10 to about 50 weight percent on a basis of total weight of the weldable coating composition.

The film-forming composition applied in step (b) can further comprise optional ingredients such as phosphorus-containing materials, including metal phosphates or organophosphates; inorganic lubricants such as GLEITMO 1000S molybdenum disulfide particles which are commercially available from Fuchs of Germany; extender pigments such as iron oxides and iron phosphides; flow control agents; thixotropic agents such as silica, montmorillonite clay and hydrogenated castor oil; anti-settling agents such as aluminum stearate and polyethylene powder; dehydrating agents which inhibit gas formation such as silica, lime or sodium aluminum silicate; and wetting agents including salts of sulfated castor oil derivatives such as DEHYSOL R.

In a particular embodiment of the present invention, the film-forming composition applied in step (b) is a weldable primer. When the metal substrates are to be subsequently welded, the weldable film-forming composition must comprise a substantial amount of electroconductive pigment, generally greater than about 10 volume percent and preferably about 30 to about 60 volume percent on a basis of total volume of electroconductive pigment and binder.

Other pigments such as carbon black, iron oxide, magnesium silicate (talc), zinc oxide and corrosion inhibiting pigments including can be included in the film-forming composition applied in step (b). Generally, these optional ingredients comprise less than about 20 weight percent of the film-forming composition on a total solids basis, and usually about 5 to about 15 weight percent. Often, the film-forming composition is essentially free of chromium-containing materials, i.e., comprises less than about 2 weight percent of chromium-containing materials and more often is free of chromium-containing materials.

In a particular embodiment of the present invention, the film-forming composition is a weldable composition and includes EPON® 1009 epoxy-functional resin, zinc dust, salt of a sulfated castor oil derivative, silica, molybdenum disulfide, red iron oxide, toluene diisocyanate blocked with caprolactam, melamine resin, dipropylene glycol methyl ether, propylene glycol methyl ether acetate and cyclohexanone.

The film-forming composition can be applied to the surface of the substrate by any conventional method well known to those skilled in the art, such as dip coating, direct roll coating, reverse roll coating, curtain coating, air and airless spraying, electrostatic spraying, pressure spraying, brushing such as rotary brush coating or a combination of any of the techniques discussed above.

The thickness of the film-forming composition applied in step (b) can vary depending upon the use to which the coated metal substrate will be subjected. Generally, to achieve sufficient corrosion resistance for automotive use, the applied film-forming composition should have a film thickness of at least about 1 micrometer (about 0.5 mils), typically about 1 to about 20 micrometers and more often about 2 to about 5 micrometers. For other substrates and other applications, thinner or thicker coatings can be used.

In step (c) of the process of the present invention, the film-forming composition applied in step (b) is preferably dried and/or any curable components thereof are cured to form a dried residue of the film-forming composition upon the substrate. The dried residue can be formed at an elevated temperature ranging up to about 300° C. peak metal temperature. Many of the binders such as those prepared from epoxy-containing materials require curing at an elevated temperature for a period of time sufficient to vaporize any diluents in the coating and to cure or set the binder. In general, baking temperatures will be dependent upon film thickness and the components of the binder.

After the film-forming composition has been dried and/or cured, the metal substrate can be stored or forwarded to other operations, such as forming, shaping, cutting and/or welding operations to form the substrate into parts such as fenders or doors (step (d)) of the process of the present invention). While the metal is being stored, transported or subjected to subsequent operations, the coatings protect the metal surface from corrosion, such as white and red rust, due to exposure to atmospheric conditions.

In step (e) of the present invention, at least a portion of the outer surface of the ferrous substrate is contacted with a treatment composition to yield a treated substrate. In one embodiment of the present invention, the entire surface of the substrate is contacted with the treatment composition. The treatment composition comprises an aqueous solution of a polymer derived from vinylidene chloride. By “polymer” is meant homopolymers and copolymers and oligomers derived from at least one monomer. Suitable solutions include, for example, Haloflex® 202, a copolymer of vinyl and acrylic monomers with vinylidene chloride, available from NeoResins, Inc. The polymer is typically present in an amount of about 5 to 50 percent by weight, often 10 to 30 percent by weight, based on the total weight of the treatment composition.

The treatment composition may further comprise one or more compounds such as ferric compounds including ferric chloride, ferric phosphate, ferric oxide, ferric nitrate, ferric sulfate, and ferric fluoride; calcium salts such as calcium metaborate; aluminum salts such as aluminum triphosphate; other fluorides including ammonium bifluoride, chromium fluoride, cadmium fluoride, stannous fluoride and the like. The compounds are typically present in an amount of about 0.1 to 10 percent by weight 0.1 to 5 percent by weight or 0.1 to 0.75 percent by weight each, based on the total weight of the treatment composition.

Additional ingredients may include surfactants, oximes such as acetaldehyde oxime and methyl ethyl ketoxime, wetting agents, pH adjustment components, corrosion inhibitors, pigments, flow additives, and rheology modifiers. The additional components are each typically present in an amount of about 0.1 to 10 percent by weight, based on the total weight of the treatment composition.

In a particular embodiment of the present invention, the treatment composition comprises a composition available as LOC-COAT 7707 from Lockhart Chemical Company.

Following step (e), the ferrous substrate may be rinsed with deionized water or an aqueous solution of rinsing agents in order to remove any residue. The metal substrate can be air dried using an air knife, by flashing off the water by brief exposure of the substrate to a high temperature or by passing the substrate between squeegee rolls.

The treatment composition applied in step (e) of the process of the present invention may serve as a pretreatment (i.e., “passivation”) of the substrate as understood in the conventional sense. Alternatively, the process of the present invention may further comprise a step of contacting the surface of the ferrous substrate with at least one separate pretreatment composition different from the treatment composition, prior to contacting the substrate with the treatment composition in step (e).

A pretreatment composition serves to protect the substrate from corrosion and facilitates adhesion of subsequently applied coating compositions to the ferrous metal substrate. The thickness of the pretreatment film can vary, but is generally less than 1 micrometer, or ranges from 1 to 500 nanometers, or from 10 to about 300 nanometers.

The pretreatment composition may be selected from at least one of metal phosphate coatings such as zinc phosphate, iron phosphate, and the like. In one embodiment of the present invention, the pretreatment composition comprises one or more lanthanide, Group IIIB or IVB element-containing compounds or mixtures thereof dissolved or dispersed in a carrier medium, typically an aqueous medium. The Group IIIB and IVB elements are defined by the CAS Periodic Table of the Elements as shown, for example, in the Handbook of Chemistry and Physics, (83rd Ed. 2003). The Group IIIB or IVB metal compounds are often in the form of water soluble metal salts or acids.

When the pretreatment composition comprises a Group IIIB or IVB metal compound, the metal compound typically is present in the carrier medium in an amount of 10 to 5000 ppm metal, and can range from 100 to 300 ppm metal.

Additionally, the pretreatment composition may contain a film-forming resin. Suitable resins include reaction products of one or more alkanolamines and an epoxy-functional material containing at least two epoxy groups, such as those disclosed in U.S. Pat. No. 5,653,823. Such resins often contain beta hydroxy ester, imide, or sulfide functionality, incorporated by using dimethylolpropionic acid, phthalimide, or mercaptoglycerine as an additional reactant in the preparation of the resin. Alternatively, the reaction product may be that of the diglycidyl ether of Bisphenol A (commercially available from Shell Chemical Company as EPON 880), dimethylol propionic acid, and diethanolamine in a 0.6 to 5.0:0.05 to 5.5:1 mole ratio. Other suitable resins include water soluble and water dispersible polyacrylic acids as disclosed in U.S. Pat. Nos. 3,912,548 and 5,328,525; phenol-formaldehyde resins as described in U.S. Pat. No. 5,662,746, incorporated herein by reference; water soluble polyamides such as those disclosed in WO 95/33869; copolymers of maleic or acrylic acid with allyl ether as described in Canadian patent application 2,087,352; and water soluble and dispersible resins including epoxy resins, aminoplasts, phenol-formaldehyde resins, tannins, and polyvinyl phenols as discussed in U.S. Pat. No. 5,449,415.

In this embodiment of the invention, the film-forming resin is present in the pretreatment composition in an amount of 0.005% to 30% based on the total weight of the pretreatment composition, and the group IIIB or IVB metal compound is present in an amount of 10 to 5000, preferably 100 to 1000, ppm metal based on total weight of the pretreatment composition. The weight ratio of the resin to Group IIIB or IVB metal or metal compound is from 2.0 to 10.0, preferably 3.0 to 5.0, based on metal.

The pretreatment composition can further comprise surfactants that function as aids to improve wetting of the substrate. Generally, the surfactant materials are present in an amount of less than about 2 weight percent on a basis of total weight of the pretreatment coating composition. Other optional materials in the carrier medium include surfactants that function as defoamers or substrate wetting agents.

In an embodiment of the present invention, the treatment composition and any pretreatment compositions are essentially free of chromium-containing materials, i.e., they contain less than 2 weight percent of chromium-containing materials (expressed as CrO₃), and can contain less than 0.05 weight percent of chromium-containing materials. Examples of such chromium-containing materials include chromic acid, chromium trioxide, chromic acid anhydride, dichromate salts such as ammonium dichromate, sodium dichromate, potassium dichromate, and calcium, barium, magnesium, zinc, cadmium and strontium dichromate. Most often, the compositions are free of chromium-containing materials.

The treatment composition of step (e) and any pretreatment compositions may be applied to the surface of the metal substrate by any conventional application technique, such as spraying, immersion or roll coating in a batch or continuous process. Immersion is most often used. The temperature of the composition at application is typically 10° C. to 85° C., and can be 15° C. to 60° C. The pH of the treatment composition at application generally ranges from 1.0 to 10.0 and can range from 1.5 to 5.5. The pH of the medium may be adjusted using mineral acids such as hydrofluoric acid, fluoroboric acid, phosphoric acid, and the like, including mixtures thereof; organic acids such as lactic acid, acetic acid, citric acid, sulfamic acid, or mixtures thereof; and water soluble or water dispersible bases such as sodium hydroxide, ammonium hydroxide, ammonia, or amines such as triethylamine, methylethyl amine, or mixtures thereof.

After the treatment composition and any pretreatment compositions have been applied to the metal surface, the metal can be rinsed with deionized water as mentioned above and dried at room temperature or at elevated temperatures to remove excess moisture from the treated substrate surface and cure any curable coating components to form the pretreatment coating. Alternately, the treated substrate can be heated at about 65° C. to about 125° C. for at least about seconds to produce a coated substrate having a dried residue of the treatment coating composition thereon. The temperature and time for drying the coating will depend upon such variables as the percentage of solids in the coating, components of the composition and type of substrate.

In a particular embodiment of the present invention, the process further comprises a step of applying a waterborne polymeric composition to the ferrous substrate prior to applying at least one additional coating to the treated substrate in step (f). The polymer present in the polymeric composition typically is different from the polymer derived from vinylidene chloride as described above, and is selected from at least one of acrylic, polyester, polyurethane, and polyepoxides. Usually, the polymer comprises an acrylic latex.

Generally these polymers can be any polymers of these types made by any method known to those skilled in the art where the polymers are water dispersible or emulsifiable and usually of limited water solubility.

Suitable acrylic polymers include copolymers of one or more alkyl esters of acrylic acid or methacrylic acid, optionally together with one or more other polymerizable ethylenically unsaturated monomers. Useful alkyl esters of acrylic acid or methacrylic acid include aliphatic alkyl esters containing from 1 to 30, and preferably 4 to 18 carbon atoms in the alkyl group. Non-limiting examples include methyl methacrylate, ethyl methacrylate, butyl methacrylate, ethyl acrylate, butyl acrylate, and 2-ethyl hexyl acrylate. Suitable other copolymerizable ethylenically unsaturated monomers include vinyl aromatic compounds such as styrene and vinyl toluene; nitriles such as acrylonitrile and methacrylonitrile; vinyl and vinylidene halides such as vinyl chloride and vinylidene fluoride and vinyl esters such as vinyl acetate.

The acrylic copolymer can include hydroxyl functional groups, which are often incorporated into the polymer by including one or more hydroxyl functional monomers in the reactants used to produce the copolymer. Useful hydroxyl functional monomers include hydroxyalkyl acrylates and methacrylates, typically having 2 to 4 carbon atoms in the hydroxyalkyl group, such as hydroxyethyl acrylate, hydroxypropyl acrylate, 4-hydroxybutyl acrylate, hydroxy functional adducts of caprolactone and hydroxyalkyl acrylates, and corresponding methacrylates, as well as the beta-hydroxy ester functional monomers described below. The acrylic polymer can also be prepared with N-(alkoxymethyl) acrylamides and N-(alkoxymethyl)methacrylamides.

Acrylic polymers can be prepared via aqueous emulsion polymerization techniques and used directly in the preparation of the aqueous coating compositions, or can be prepared via organic solution polymerization techniques with groups capable of salt formation such as acid or amine groups. Upon neutralization of these groups with a base or acid the polymers can be dispersed into aqueous medium. Generally any method of producing such polymers that is known to those skilled in the art utilizing art recognized amounts of monomers can be used.

Besides acrylic polymers, the polymer used in the waterborne polymeric composition may be an alkyd resin or a polyester. Such polymers may be prepared in a known manner by condensation of polyhydric alcohols and polycarboxylic acids. Suitable polyhydric alcohols include, but are not limited to, ethylene glycol, propylene glycol, butylene glycol, 1,6-hexylene glycol, neopentyl glycol, diethylene glycol, glycerol, trimethylol propane, and pentaerythritol. Suitable polycarboxylic acids include, but are not limited to, succinic acid, adipic acid, azelaic acid, sebacic acid, maleic acid, fumaric acid, phthalic acid, tetrahydrophthalic acid, hexahydrophthalic acid, and trimellitic acid. Besides the polycarboxylic acids mentioned above, functional equivalents of the acids such as anhydrides where they exist or lower alkyl esters of the acids such as the methyl esters may be used. Where it is desired to produce air-drying alkyd resins, suitable drying oil fatty acids may be used and include, for example, those derived from linseed oil, soya bean oil, tall oil, dehydrated castor oil, or tung oil.

Polyurethanes can also be used as the polymer in the waterborne polymeric composition. Among the polyurethanes which can be used are polymeric polyols which generally are prepared by reacting the polyester polyols or acrylic polyols such as those mentioned above with a polyisocyanate such that the OH/NCO equivalent ratio is greater than 1:1 so that free hydroxyl groups are present in the product. The organic polyisocyanate which is used to prepare the polyurethane polyol can be an aliphatic or an aromatic polyisocyanate or a mixture of the two. Diisocyanates are preferred, although higher polyisocyanates can be used in place of or in combination with diisocyanates. Examples of suitable aromatic diisocyanates are 4,4′-diphenylmethane diisocyanate and toluene diisocyanate. Examples of suitable aliphatic diisocyanates are straight chain aliphatic diisocyanates such as 1,6-hexamethylene diisocyanate. Also, cycloaliphatic diisocyanates can be employed. Examples include isophorone diisocyanate and 4,4′-methylene-bis-(cyclohexyl isocyanate). Examples of suitable higher polyisocyanates are 1,2,4-benzene triisocyanate and polymethylene polyphenyl isocyanate. As with the polyesters, the polyurethanes can be prepared with unreacted carboxylic acid groups, which upon neutralization with bases such as amines allows for dispersion into aqueous medium.

Suitable polyepoxides include chain extended polyepoxides, typically prepared by reacting together a polyepoxide and a polyhydroxyl or polycarboxyl group-containing material. The reactants may be combined neat or in the presence of an inert organic solvent such as a ketone, including methyl isobutyl ketone and methyl amyl ketone, aromatics such as toluene and xylene, and glycol ethers such as the dimethyl ether of diethylene glycol. The reaction is usually conducted at a temperature of about 80° C. to 160° C. for about 30 to 180 minutes until an epoxy group-containing resinous reaction product is obtained.

In general the epoxide equivalent weight of the polyepoxide will range from 100 to about 2000, typically from about 180 to 500. The epoxy compounds may be saturated or unsaturated, cyclic or acyclic, aliphatic, alicyclic, aromatic or heterocyclic. They may contain substituents such as halogen, hydroxyl, and ether groups.

Examples of polyepoxides are those having a 1,2-epoxy equivalency greater than one and usually about two; that is, polyepoxides which have on average two epoxide groups per molecule. Exemplary polyepoxides are polyglycidyl ethers of polyhydric alcohols. Polyhydric alcohols may be selected from resorcinol, hydroquinone, benzenedimethanol, phloroglucinol, catechol, and mixtures thereof. These polyglycidyl ethers of polyhydric alcohols can be produced by etherification of polyhydric alcohols with an epihalohydrin or dihalohydrin such as epichlorohydrin or dichlorohydrin in the presence of alkali. Besides the polyhydric alcohols listed above, other polyols can be used in preparing the polyglycidyl ethers of polyhydric alcohols. Examples of cyclic polyols include alicyclic polyols, particularly cycloaliphatic polyols such as 1,2-cyclohexane diol, 1,4-cyclohexane diol, 2,2-bis(4-hydroxycyclohexyl)propane, 1,1-bis(4-hydroxycyclohexyl)ethane, 2-methyl-1,1-bis(4-hydroxycyclohexyl)propane, 2,2-bis(4-hydroxy-3-tertiarybutylcyclohexyl)propane, 1,3-bis(hydroxymethyl)cyclohexane and 1,2-bis(hydroxymethyl)cyclohexane. Examples of aliphatic polyols include, inter alia, trimethylpentanediol and neopentyl glycol.

Examples of polyhydroxyl group-containing materials used to chain extend or increase the molecular weight of the polyepoxide (i.e., through hydroxyl-epoxy reaction) include all the alcoholic hydroxyl group-containing materials and phenolic hydroxyl group-containing materials listed above; polyester polyols such as those described in U.S. Pat. No. 4,148,772, incorporated herein by reference; and urethane diols such as those described in U.S. Pat. No. 4,931,157, incorporated herein by reference. Mixtures of alcoholic hydroxyl group-containing materials and phenolic hydroxyl group-containing materials may also be used.

Phenolic hydroxyl group-containing materials having aliphatic carbon atoms to which is bonded more than one aromatic group are also suitable for use to chain extend or increase the molecular weight of the polyepoxide. Bisphenol A is an example of such a phenolic compound.

The equivalent ratio of reactants; i.e., epoxy:polyhydroxyl group-containing material during chain extension is typically from about 1.00:0.75 to 1.00:2.00.

The chain extension of the polyepoxides may alternatively be performed with a polycarboxylic acid material, such as a dicarboxylic acid. Useful dicarboxylic acids include acids having the general formula: HOOC—R—COOH, where R is a divalent moiety that is substantially unreactive with the polyepoxide. R can be a straight chained or a branched alkylene or alkylidene moiety normally containing from 2 to 42 carbon atoms. Some examples of suitable dicarboxylic acids include cyclohexanedicarboxylic acid, adipic acid, 3,3-dimethylpentanedioic acid, benzenedicarboxylic acid, phenylenediethanoic acid, naphthalenedicarboxylic acid, pimelic acid, suberic acid, azelaic acid, sebacic acid and the like. Additional suitable dicarboxylic acids include substantially saturated acyclic, aliphatic dimer acids formed by the dimerization reaction of fatty acids having from 4 to 22 carbon atoms and a terminal carboxyl group (forming dimer acids having from 8 to 44 carbon atoms). Dimer acids are well known in the art and are commercially available from Emery Industries, Inc. under the name EMPOL®.

Dicarboxylic acids can be formed as reaction products of anhydrides and diols or diamines at reaction conditions and techniques known to those skilled in the art for the particular reactants. Diols can include polytetramethylene glycols, polycaprolactones, polypropylene glycols, polyethylene glycols and the like. Suitable anhydrides include maleic, phthalic, hexahydrophthalic, tetrahydrophthalic and the like. Additionally, dicarboxylic acids formed by the reaction of an anhydride and a diamine can be used. Dicarboxylic acids formed by the reaction of a polyoxyalkylenediamine such as polyoxypropylenediamine, commercially available from Huntsman Chemical Company under the name JEFFAMINE®, with an anhydride like those listed above can be used.

Typically, the amount of dicarboxylic acid used to chain extend the polyepoxide is sufficient to provide from about 0.05 to 0.6, often from about 0.2 to 0.4 acid groups per epoxide group. This reaction is normally carried out at between about 80° C. to 175° C.

Materials having mixed hydroxyl and carboxyl functionality, such as 2-hydroxypivalic acid, are also suitable for use as chain extending agents.

The waterborne polymeric composition may be applied to the ferrous substrate simultaneously with the treatment composition in step (e). In this embodiment, the waterborne polymeric composition may be applied to the ferrous substrate as a separate package, or it may be integral to (i.e., the polymer is an additional component of) the treatment composition applied in step (e). When the polymer is part of the treatment composition, it is typically present in an amount ranging from 2 to 30 percent by weight, or ranging from 5 to 25 percent by weight, based on the total weight of the treatment composition.

Alternatively, the waterborne polymeric composition may be applied to the ferrous substrate after contacting the substrate with the treatment composition in step (e) and prior to applying at least one coating composition to the treated substrate in step (f).

In step (f) of the present invention, at least one coating composition is applied to the treated substrate to form a coated substrate. Such coating compositions may be selected from one or more primer coating compositions, pigmented or colored base coats, transparent or clear top coats, monocoats, and combinations thereof. Suitable coating compositions include any known to those skilled in the art. The coating compositions may be powder compositions or liquid, including solventborne and waterborne compositions.

The coating compositions applied during step (f) can be applied to the surface of the treated substrate by any conventional method known to those skilled in the art. Application methods include dip coating, direct roll coating, reverse roll coating, curtain coating, air and airless spraying, electrostatic spraying, pressure spraying, brushing such as rotary brush coating or a combination of any of the techniques discussed above. Coating compositions being applied over a weldable composition may be electrodepositable, because of the electroconductive nature of the pigments used in weldable compositions. Application conditions such as temperature, humidity, etc. may vary depending on the composition of the coating to be applied.

The thickness of each of the aforementioned coatings can vary depending upon the use to which the coated metal substrate will be subjected. Colored base coats typically have a thickness of 0.1 to 5 mils (2.54 to 127 microns), or 0.1 to 2 mils (2.54 to 50.4 microns). Clear topcoat thickness (dry film thickness) is typically 1 to 6 mils (25.4 to 152.4 microns). For other substrates and/or other applications, thinner or thicker coatings can be used.

After application, the coating(s) usually is dried and/or any curable components thereof are cured to form a dried residue or film of the coating(s) upon the substrate. The dried residue or film can be formed at an elevated temperature ranging up to about 300° C. peak metal temperature. Many of the binders used in thermosetting coating compositions require curing at an elevated temperature for a period of time sufficient to vaporize any diluents in the coating and to cure or set the binder. In general, baking temperatures will be dependent upon film thickness and the components of the binder.

1. A process for applying a multi-layer coating to at least a portion of a formed ferrous substrate, the process comprising the steps of:
(a) providing a ferrous substrate;
(b) applying to at least a portion of the ferrous substrate a film-forming composition that contains at least one of a corrosion inhibiting pigment and an electroconductive pigment;
(c) curing the film-forming composition that was applied to the ferrous substrate in step (b);
(d) forming the ferrous substrate into an end-use shape;
(e) contacting at least a portion of the formed ferrous substrate with a treatment composition to yield a treated substrate; and
(f) applying at least one coating composition to at least a portion of the treated substrate to form a coated substrate; wherein the treatment composition applied in step (e) comprises an aqueous solution of a polymer derived from vinylidene chloride.

2. The process according to claim 1, further comprising a step of cleaning the surface of the ferrous substrate with a cleaning composition prior to contacting the substrate with the treatment composition in step (e).

3. The process according to claim 1, further comprising a step of contacting at least a portion of the surface of the ferrous substrate with at least one pretreatment composition prior to contacting the substrate with the treatment composition in step (e).

4. The process according to claim 3, wherein the pretreatment composition contains at least one of zinc phosphate, iron phosphate, lanthanide element-containing compounds, Group IIIB element-containing compounds, and Group IVB element-containing compounds dissolved or dispersed in a carrier medium.

5. The process according to claim 1, further comprising a step of rinsing the surface of the treated substrate after contacting the substrate with the treatment composition in step (e) and prior to applying at least one additional coating to the treated substrate in step (f).

6. The process according to claim 1, further comprising a step of applying a waterborne polymeric composition to at least a portion of the ferrous substrate prior to applying at least one additional coating to the treated substrate in step (f).

7. The process according to claim 6, wherein the waterborne polymeric composition is applied to the ferrous substrate simultaneously with the treatment composition in step (e).

8. The process according to claim 6, wherein the waterborne polymeric composition is applied to the ferrous substrate after contacting the substrate with the treatment composition in step (e) and prior to applying at least one coating composition to the treated substrate in step (f).

9. The process according to claim 6, wherein the waterborne polymeric composition comprises an acrylic latex.

10. The process according to claim 9, wherein the treatment composition used in step (e) further comprises at least one ferric and/or fluoride compound selected from at least one of ferric chloride, ferric phosphate, ferric oxide, ferric nitrate, ferric sulfate, ferric fluoride, ammonium fluoride, chromium fluoride, cadmium fluoride, and stannous fluoride, present in an amount of 0.1 to 10 percent by weight each, based on the total weight of the treatment composition.

11. The process according to claim 9, wherein the treatment composition used in step (e) further comprises at least one oxime selected from at least one of acetaldehyde oxime and methyl ethyl ketoxime.

12. The process according to claim 9, wherein the treatment composition used in step (e) comprises a polymer derived from vinylidene chloride, an acrylic latex, calcium metaborate, and aluminum triphosphate.

13. The process according to claim 9, wherein the treatment composition used in step (e) comprises a polymer derived from vinylidene chloride, an acrylic latex, ferric fluoride, and acetaldehyde oxime.

14. The process according to claim 6, further comprising an additional step of rinsing at least a portion of the surface of the treated substrate after contacting the substrate with the waterborne polymeric composition and prior to applying at least one coating composition to the treated substrate in step (e).

15. The process according to claim 1, wherein the treatment composition further comprises a polymer different from the polymer derived from vinylidene chloride, said different polymer being selected from at least one of acrylic polymers, polyester polymers, polyurethane polymers, and polyepoxides.

16. The process according to claim 1, wherein at least a primer coating composition is applied during step (f).

17. The process according to claim 1, further comprising an additional step of heating the coated metal substrate after applying at least one coating composition in step (f).

18. The process according to claim 1, wherein the film-forming composition applied in step (b) is a weldable primer.
